(19) United States
(12) Patent Application Publication
(10) Pub. No.: US 2008/0121059 A1
(43) Pub. Date: May 29, 2008

(54) Toothed steel cable transmission mechanism

(75) Inventor: Chang-Hung Tsai, Taipei City (TW)

Correspondence Address: TROXELL LAW OFFICE PLLC;SUITE 14044, 5205 LEESBURG PIKE, FALLS CHURCH, VA, 22041, US

(73) Assignee: Double H Technology Co.

(21) Appl. No.: 11/487,496

(22) Filed: Jul. 17, 2006

(51) Int. Cl. F16H 1/16; E05F 15/16

(52) U.S. Cl. 74/425; 49/324

(57) ABSTRACT

The invention is related to a toothed steel cable transmission mechanism, especially through a deceleration mechanism that the deceleration DC motor drives a worm, a worm gear assembly and a toothed steel cable for both linear movement in a curved section. It provides multiple benefits when it is applied to things such hopper windows, awning windows, casement windows, tilt-turn windows, sliding windows, window blinds, air vent system and skylights, or angle or height adjustment for hospital beds or sleep beds.

### BACKGROUND OF THE INVENTION

1. Field of the Invention

The invention is related to a toothed steel cable transmission mechanism, especially through a deceleration mechanism that deceleration DC motor drives a worm and a worm gear assembly and a toothed steel cable for linear movement in a curved section.

2. Description of the Prior Art

Traditional transmission mechanism has the drawbacks that additional steering mechanism is required to change transmission direction due to the non-bendable characteristic of the mechanism. Thus, the whole mechanism has increased dimension and poor transmission efficiency. Its application is also limited.

### SUMMARY OF THE INVENTION

The main objective of the invention is to improve the traditional transmission mechanism that has the drawback in failure to transmit forces in a curved path without additional steering mechanism.

After improvement, the transmission of forces through a curved mechanism can be achieved. This is the most important feature for the invention.

To achieve the above objective and function, the technical approach and scheme includes:

A toothed steel cable transmission mechanism, which consists of

a toothed steel cable, which is a long and thin steel line with surface teeth and bendability; a toothed steel cable elbow tube, which is a hollow tube to provide proper protection and orientation for the passing toothed steel cable; a DC motor, which is an electric motor in series with a deceleration mechanism to reduce output RPM; a worm, which is a rod with threads and in series with the output end of the DC motor driven deceleration mechanism; a worm gear assembly, which is made of two coaxial gears, so the driving gear runs with the worm to drive the coaxial driven gear, which further drive the toothed steel cable;

a toothed steel cable guide, a hollow sleeve with a pair of ears for securing the contact between the passing toothed steel cable and the driven gear of the gear assembly.

When the above mechanism is working, the DC motor with linear transmission characteristic transmits forces through the deceleration mechanism to the worm and the worm gear assembly to drive the toothed steel cable to make linear movement in bendable structure.

The above toothed steel cable transmission mechanism can have a top cover to accommodate the driven gear of the gear assembly and a middle cover and a bottom cover to accommodate the worm and the driving gear of the worm gear assembly. The top cover also has a connector to fit the ears of the toothed steel cable guide.

For the above transmission mechanism, the control of transmission direction for the toothed steel cable is through the DC motor steering and the worm and worm gear assembly.

For the above transmission mechanism, the end of the toothed steel cable is the power output end, which depending on applications can connect to peripherals that need switches or movement such as hopper windows, awning windows, casement windows, tilt-turn windows, sliding windows, window blinds, air vent system and skylights, or angle or height adjustment for hospital beds or sleep beds.

When the above toothed steel cable transmission mechanism is applied to window opening and closing, it is associated with a window switch on window frame, so the pull-push forces from the power output end of the toothed steel cable are transmitted to the window through the toothed steel cable.

Regarding the technical approach and mechanism to achieve the objective of the invention, embodiments with illustrations in figures are described in details as follows:

### BRIEF DESCRIPTION OF THE DRAWINGS

FIG. 1: a three-dimensional disassembly diagram for the structural exterior for the invention.

FIG. 2: a three-dimensional exterior assembly diagram for the invention.

FIG. 3: the two-dimensional illustration of the operation principle for the invention.

FIG. 4: a partial cross-sectional view for the transmission mechanism for the invention.

FIG. 5: an embodiment of the invention for a smoke vent window.

FIG. 6: a smoke vent window as an example for the invention.

### DETAILED DESCRIPTION OF THE PREFERRED EMBODIMENTS

For patent examiners to further understand the invention, examples are given as follows:

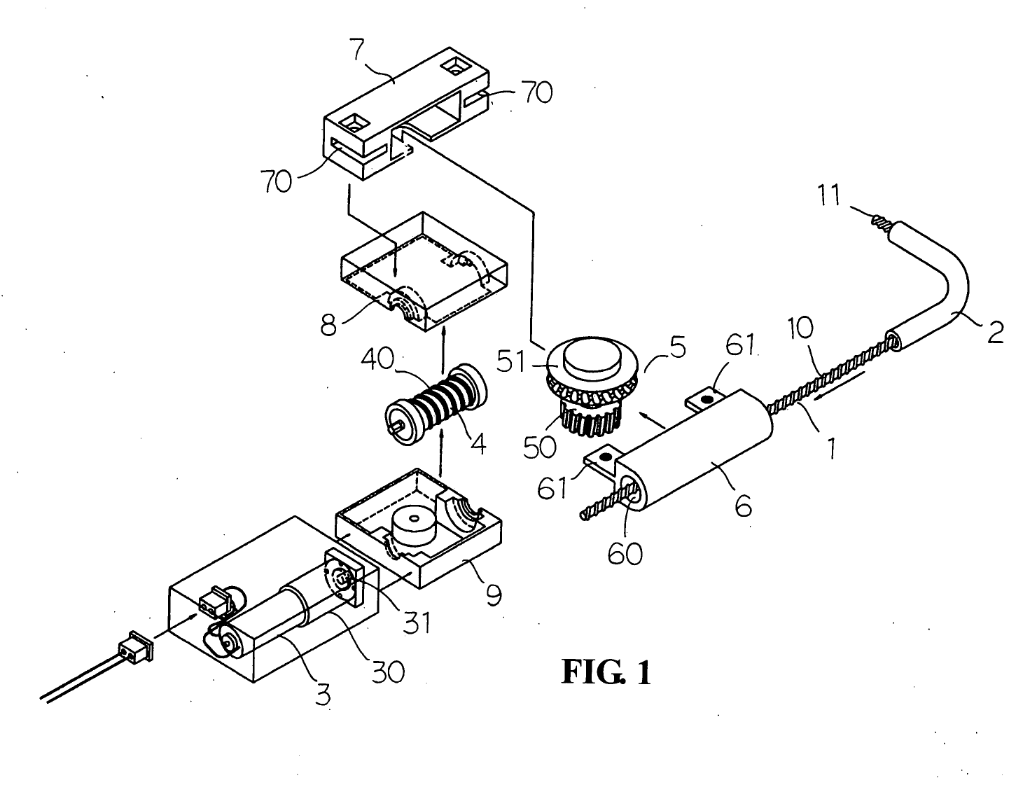

Please refer to FIG. 1 for the three-dimensional disassembly diagram for the structural exterior for the invention. The toothed steel cable 1 is a thin and long steel line that is bendable and has surface teeth 10. The elbow tube 2 is a hollow tube to properly protect and guide the passing toothed steel cable 1. The DC motor 3 is an electric motor powered by direct current. The motor is in series with a deceleration mechanism 30 that is made of a gear assembly. The worm 4 is a rod with threads 40 and in series with the output end 31 of the DC motor 3 in the deceleration mechanism 30. The worm gear assembly 5 is made of two coaxial gears. The driving gear 50 of the worm gear assembly 5 is connected with and driven by the worm 4 to drive the coaxial driven gear 51 that fits and drives the toothed steel cable 1 in linear movement.

The toothed steel cable guide 6 is a hollow tube 60 to secure the close contact between the passing toothed steel cable 1 and the driven gear 51 of the worm gear assembly 5. The toothed steel cable guide 6 has a pair of ears 61.

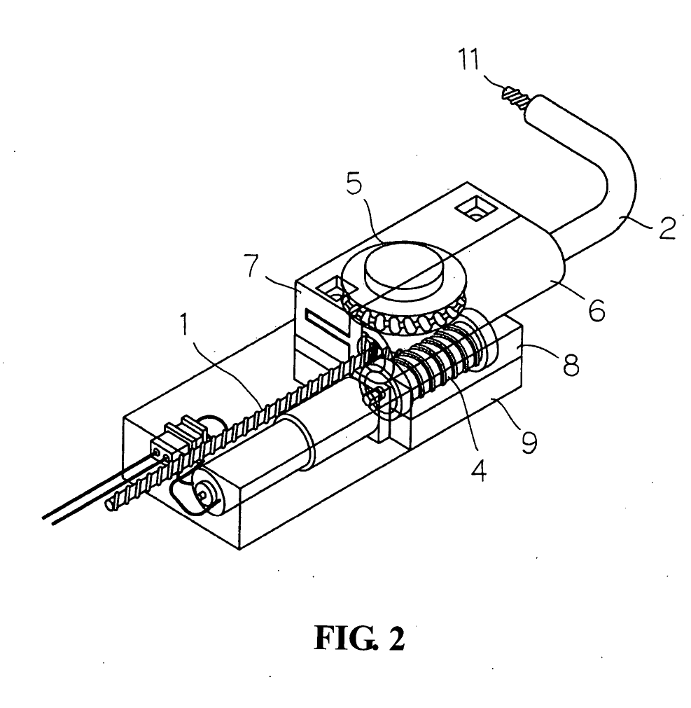

Please refer to FIG. 2 for the three-dimensional exterior assembly diagram. The DC motor 3 has linear transmission characteristic and transmits torque to the worm 4 and worm gear assembly 5 and drives the toothed steel cable 1 to make curved movement. The exterior of the toothed steel cable 1 is the elbow tube 2 for protection and orientation. The close match between the toothed steel cable 1 and the worm gear assembly 5 is achieved through the toothed steel cable guide 6. The exterior of the worm 4 and the worm gear assembly 5 is protected by a top cover 7, a middle cover 8 and a bottom cover 9.

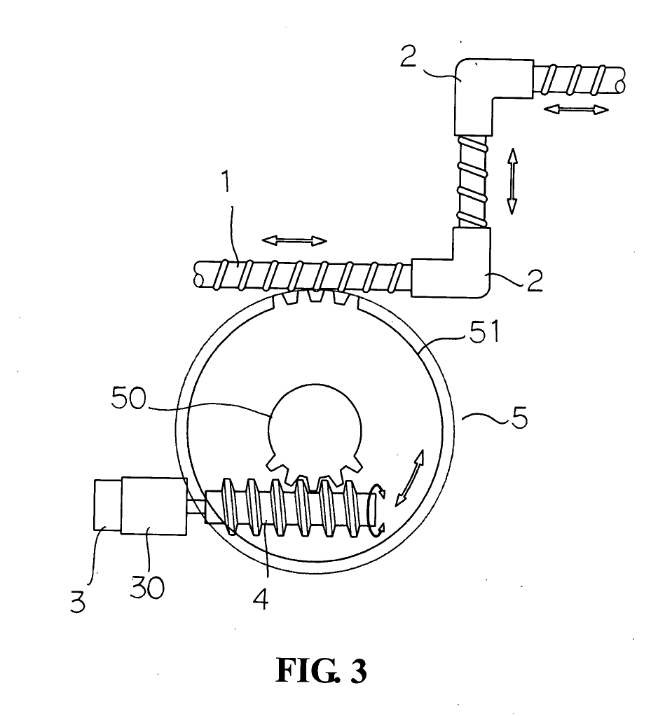

Please refer to FIG. 3 for the two-dimensional illustration of the operation principle for the invention. The power output of DC motor 3 has linear characteristic. After conversion by the deceleration mechanism 30, the torque is transmitted by the worm 4, which further transmits the power to the worm gear assembly 5 and drives the toothed steel cable 1 to make linear movement in the curved elbow tube 2.

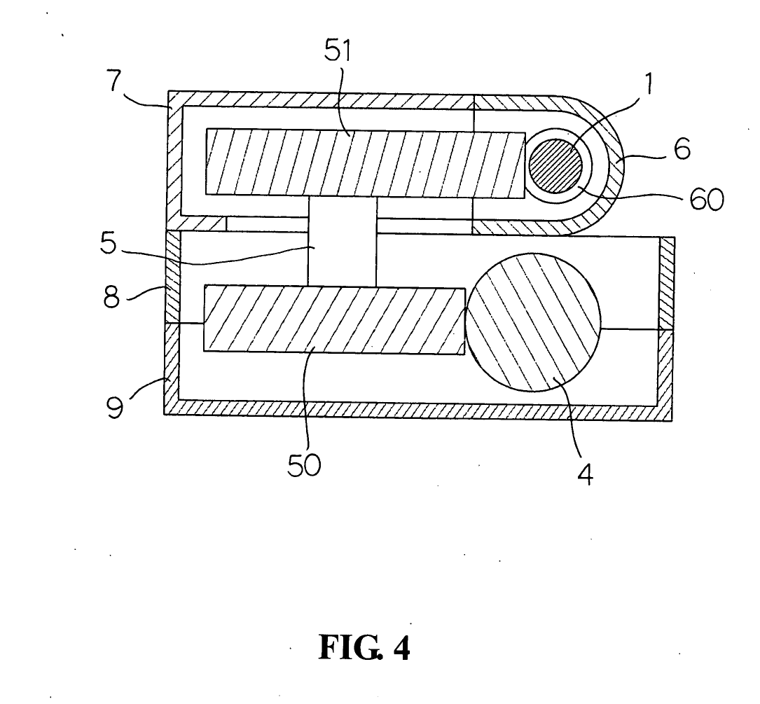

Please refer to FIG. 4 for a partial cross-sectional view for the transmission mechanism for the invention. The space inside the top cover 7 is to accommodate the driven gear 51 of the worm gear assembly 5. The space enclosed by the middle cover 8 and the bottom cover 9 is to accommodate the driving gear 50 of the worm 4 and worm gear assembly 5. The toothed steel cable 1 passes the hollow sleeve 60 of the toothed steel cable guide 6 and drives the driven gear 51 of the worm gear assembly 5.

From this figure, it is clear that the power transmission path is from the worm 4 to the driving gear 50, then through the coaxial driven gear 51 to the toothed steel cable 1.

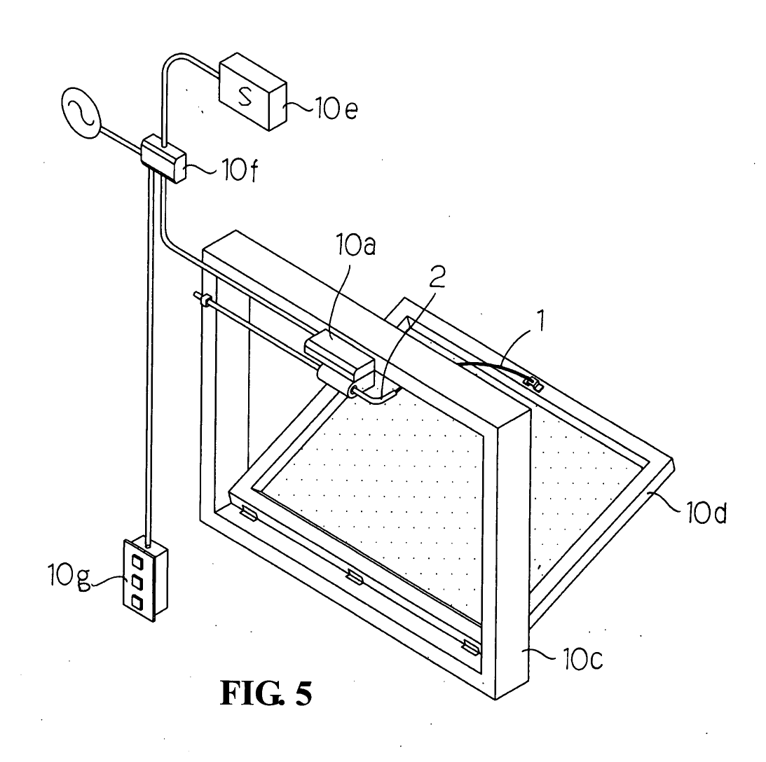

Please refer to FIG. 5 for an embodiment of the invention for a smoke vent window. The figure shows an example of a hopper window with fire-extinguishing purpose. Depending on applications, the mechanism in the invention connects to peripherals switchable or moveable, such as hopper windows, awning windows, casement windows, tilt-turn windows, sliding windows, window blinds, air vent system and skylights, or height adjustment for hospital beds or sleep beds. The opening and closing of the window panel 10d is through the switch 10a on the window frame 10c, which converts the power and transmits the power through the toothed steel cable 1 to the window panel 10d, so the window panel 10d is pushed open or pulled closed.

The linear movement of the toothed steel cable 1 inside the switch 10a is activated by an authorizing main operator 10e or a manual switch 10g, which sends fire alarm signal to the central control box 10f. Upon receiving the signal, the central control box 10f activates the DC motor assembly 3 and further transmits power through the switch 10a to the toothed steel cable 1.

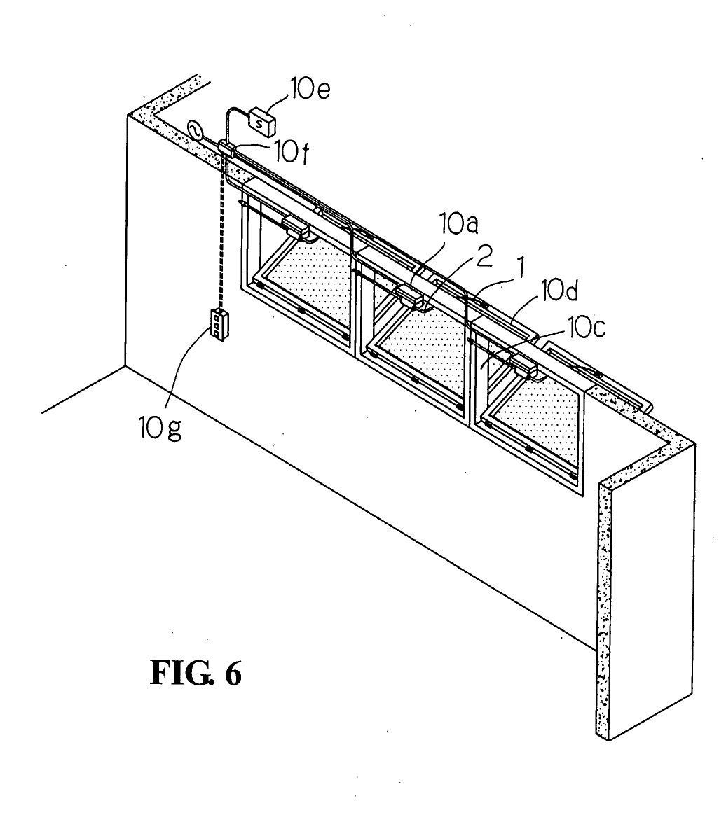

Please refer to FIG. 6 for a smoke vent window. The figure shows an example of a multi-panel hopper window. On the window frame 10c for the individual window panel 10d there is a switch 10a. Its independent power source (DC motor assembly 3) is used to control the opening and closing of the window panel 10d. Each switch assembly has a pipe (containing electric line and signal line) connecting to the central control box (containing microcomputer control chip) that operates on logic judgment.

In summary, the invention provides application technology for the toothed steel cable transmission mechanism. It is mainly through a DC motor to drive a worm and a worm gear assembly, and further drives a toothed steel cable for linear movement in a curved structure. This is the major improvement for traditional transmission mechanism. The invention provides advanced breakthrough on applications of toothed steel cable transmission mechanism and is subject to patent application approval. The above description for the invention is only the preferred embodiment. It is specially noted that any modification based on the same technical approach and design concept in the invention shall fall into the scope of the invention.

What is claimed is:

1. A toothed steel cable transmission mechanism consists of:
a toothed steel cable, which is a long and thin steel line with surface teeth and bendability;
a toothed steel cable elbow tube, which is a hollow tube to provide proper protection and orientation for the passing toothed steel cable;
a DC motor, which is an electric motor in series with a deceleration mechanism to reduce output RPM;
a worm, which is a rod with threads and in series with the output end of the DC motor driven deceleration mechanism; and
a worm gear assembly, which is made of two coaxial gears, so the driving gear runs with the worm to drive the coaxial driven gear, which further drive the toothed steel cable for linear power transmission;
a toothed steel cable guide, which is a hollow sleeve with a pair of ears for securing the contact between the passing toothed steel cable and the driven gear of the gear assembly, and adopts inner threads for locking with flexibility in rotation and angle change;
when the above mechanism is working, the DC motor with linear transmission characteristic transmits forces through the deceleration mechanism to the worm and the worm gear assembly to drive the toothed steel cable to make linear movement in bendable structure.

2. As described in claim 1 for a toothed steel cable transmission mechanism, it further has a top cover which inside space is to accommodate the driven gear of the worm gear assembly and a middle cover and a bottom cover which enclosed space is to accommodate the worm and driving gear of the worm gear assembly; the top cover also has a connector to fit the ears of the toothed steel cable guide.

3. As described in claim 1 for a toothed steel cable transmission mechanism, the control of linear push-pull for the toothed steel cable is through the steering by the DC motor and the control by the worm and worm assembly gear.

4. As described in claim 1 for a toothed steel cable transmission mechanism, the end of the toothed steel cable is the power output end, which depending on applications can connect to peripherals that need switches or movement such as hopper windows, awning windows, casement windows, tilt-turn windows, sliding windows, window blinds, air vent system and skylights.

5. As described in claim 4 for a toothed steel cable transmission mechanism, the opening and closing is through a switch on window frame that transmits the push-pull forces through the toothed steel cable to window panel.

6. As described in claim 1 for a toothed steel cable transmission mechanism, the end of the toothed steel cable is the power output end, which depending on applications can connect to peripherals that need height or angle adjustment such as hospital beds or sleep beds.
